(19) United States
(12) Patent Application Publication
(10) Pub. No.: US 2014/0017482 A1
(43) Pub. Date: Jan. 16, 2014

(54) Glassy Metal Fiber Laminate

(71) Applicants: Charles D. TUFFILE, Dighton, MA (US); Tyler F. WEZNER, Riverside, RI (US); Patrick E. MACK, Milford, MA (US); John V. COSTA, Somerset, MA (US)

(72) Inventors: Charles D. TUFFILE, Dighton, MA (US); Tyler F. WEZNER, Riverside, RI (US); Patrick E. MACK, Milford, MA (US); John V. COSTA, Somerset, MA (US)

(21) Appl. No.: 13/942,340

(22) Filed: Jul. 15, 2013

Related U.S. Application Data
(60) Provisional application No. 61/671,186, filed on Jul. 13, 2012.

(51) Int. Cl. B32B 17/10

(52) U.S. Cl. CPC B32B 17/10
USPC 428/301.1; 156/305; 156/285

(57) ABSTRACT

A laminate and a method of forming the laminate, including a fiber reinforced polymer layer and a glassy metal foil layer. The fiber reinforced polymer layer comprises fibers present in a polymer matrix. The glassy metal foil layer comprises an iron based glass forming alloy including nickel, boron, silicon and optionally chromium and exhibits spinodal glass matrix microconstituents including a glass matrix and a semicrystalline/crystalline phase.

### CROSS-REFERENCE TO RELATED APPLICATIONS

The present application claims the benefit of the filing date of U.S. Provisional Application No. 61/671,186 filed on Jul. 13, 2012, the teachings of which are incorporated by reference herein.

### FIELD OF INVENTION

This disclosure relates to the use of glassy foils in the construction of fiber metal laminate hybrid structures for a dramatic reduction in weight at an equivalent strength to prior art fiber metal laminates such as, but not limited, to those based on aluminum. Other notable improvements include, but are not limited to, improved part manufacturability, better damage tolerance, impact resistance, fatigue life, wear resistance, and flame resistance.

### BACKGROUND

Fiber metal laminates can be constructed using alternating layers of flat sheets of metallic material and various types of polymer infused fibers such as carbon fiber, glass fiber or aramid fiber. The polymer matrix serves as the bonding medium for the metal. Prior to manufacturing, the metal may be cleaned and put through an acid treatment, anodized, and treated with a surface primer to promote adhesion to the polymer.

Examples of fiber metal laminate structures include, Glass Fiber Reinforced Aluminum laminates (GLARE™), Aramid Reinforced Aluminum laminates (ARALL™), and Glass Reinforced Titanium laminates (TiGR™). GLARE™ is the most popular variation and is known for its use in the crown panels and leading edge stabilizers on the Airbus A-380 commercial airliner.

The GLARE product is manufactured as a flat sheet and is then bent into a desired shape. This presents limitations in panel thickness due to high internal stresses at bend locations and when a thicker cross section is required; multiple panels are bent separately and nested within each other.

### SUMMARY

An aspect of the present disclosure relates to a glassy metal fiber laminate. The laminate includes a fiber reinforced polymer layer and a glassy metal foil layer. The fiber reinforced polymer layer comprises fibers present in a polymer matrix. The glassy metal foil layer comprises an iron based glass forming alloy including nickel, boron, silicon and optionally chromium and exhibits spinodal glass matrix microconstituents including a glass matrix and a semicrystalline/crystalline phase.

Another aspect of the present disclosure relates to a method of forming a glassy metal fiber laminate. The method includes providing a fiber reinforced polymer layer, providing a glassy metal foil layer, and forming a laminate of the fiber reinforced polymer layer and the glassy metal foil layer. The fiber reinforced polymer layer comprises fibers present in a polymer matrix and the glassy metal foil layer comprises an iron based glass forming alloy including nickel, boron, silicon and optionally chromium and exhibits spinodal glass matrix microconstituents including a glass matrix and a semicrystalline/crystalline phase.

### DETAILED DESCRIPTION

This disclosure relates to the use of glassy foils in the construction of fiber metal laminate hybrid structures for a dramatic reduction in weight at an equivalent strength to prior art fiber metal laminates such as, but not limited, to those based on aluminum. Other notable improvements include, but are not limited to, improved part manufacturability, better damage tolerance, impact resistance, fatigue life, wear resistance, and flame resistance. A laminate is understood as a material that is composed of layers, which in some embodiments are firmly united. In addition, the layers may be coterminous. However, in other embodiments, the layers are not coterminous.

A fiber reinforced polymer is made up of fibers in a polymer matrix that acts as a binding agent. Fibers that may be used in such materials may include, for example, carbon fiber, glass fiber, or aramid fibers. Polymer matrices may include, for example, epoxy, vinylester, polyester or phenol formaldehyde type thermoset resins or polyethylene terephthalate (PET), polyether ether ketone (PEEK), polysulfone (PSU), or polyetherimide (PEI) thermoplastic resins. The fibers may be oriented in the same direction or woven to create various types of fabric in order to fine tune the mechanical properties of the composite structure. The outcome of using this technology is a high strength, light weight material.

It is well known that fiber reinforced composite materials have a low damage tolerance, and when damage is present it is difficult to detect before catastrophic failure occurs. This inherent limitation makes the use of fiber reinforced composite materials risky in critical applications such as aerospace, automotive, and recreational where structural integrity is desired and loss of life can result from catastrophic failure. It is possible to increase the damage tolerance of fiber reinforced composite materials by the addition of metallic sheets, as seen in the GLARE, TiGR, and ARALL structures but this reduces the specific strength of the material (strength/density ratio).

One benefit to using glassy steel foils in a fiber metal laminate (FML) is that the specific strength may be twice that of 2024-T3 aluminum. This can result in a 50% weight reduction of the metallic component in the fiber metal laminate structure for the same FML strength. Also, like current fiber metal laminates, the glassy steel foil has a unique ability to yield after impact thus creating a visual indication that damage is present and reducing the risk of catastrophic failure.

The glassy steel foil may be formed utilizing glass forming chemistries that lead to the development of Spinodal Glass Matrix Microconstituents (SGMM) structures, which may exhibit relatively significant ductility and high tensile strength. Spinodal glass matrix microconstituents are understood as microconstituents (i.e., crystalline or glass phases) in a glassy matrix that are formed by a transformation mechanism that is not nucleation controlled. More basically, spinodal decomposition is understood as a mechanism by which a solution of two or more components (e.g., metal compositions) of the alloy can separate into distinct regions (or phases) with distinctly different chemical compositions and physical properties. This mechanism differs from classical nucleation in that phase separation occurs uniformly throughout the material and not just at discrete nucleation sites. The phases include one or more semicrystalline clusters or crystalline phases, which may therefore form through a successive diffusion of atoms on a local level until the chemistry fluctuations lead to at least one distinct crystalline phase. Semi-crystalline clusters are understood herein as exhibiting a largest linear dimension of 2 nm or less, whereas crystalline clusters exhibit a largest linear dimension of greater than 2 nm. Note that during the early stages of spinodal decomposition, the clusters which are formed may be relatively small and while their chemistry differs from a surrounding glass matrix, they are not yet fully crystalline and have not yet achieved well-ordered crystalline periodicity. Additional crystalline phases may exhibit the same crystal structure or distinct structures. Furthermore, as noted the phases include a glass matrix. The glass matrix is understood to include microstructures that may exhibit associations of structural units in the solid phase that may be randomly packed together. The level of refinement, or the size, of the structural units in the glass phase may be in the angstrom scale range, i.e., 5 Å to 100 Å.

Spinodal glass matrix microconstituent formation is quite different than the devitrification of a metallic glass. Metallic glasses may exhibit characteristics which are both metal like, (since they may contain non-directional metallic bonds, metallic luster, and relatively significant electrical and thermal conductivity), and ceramic like (since relatively high hardness may often be exhibited coupled with brittleness and the lack of tensile ductility). Metallic glasses may be understood to include supercooled liquids that exist in solid form at room temperature but which may have structures that are similar to what is found in the liquid with only short range order present. Metallic glasses may generally have free electrons, exhibit metallic luster, and exhibit metallic bonding similar to what is found in conventional metals. Metallic glasses may be understood to be metastable materials and when heated up, they may transform into a crystalline state through crystallization or devitrification. Since diffusion may be limited at room temperature, enough heat (i.e. Boltzman's Energy) may be to be applied to overcome the nucleation barrier to cause a solid-solid state transformation which is caused by glass devitrification.

The alloys leading to the Spinodal Glass Matrix Microconstituent structures may exhibit induced Shear Band Blunting (ISBB) and Shear Band Arresting Interactions (SBAI) which may be enabled by the spinodal glass matrix microconstituent (SGMM). ISBB is understood as the ability to blunt and stop propagating shear bands through interactions with the SGMM structure. SBAI is understood as the arresting of shear bands through shear band/shear band interactions and may occur after the initial or primary shear bands are blunted through ISBB.

While conventional materials may deform through dislocations moving on specific slip systems in crystalline metals, ISBB and SBAI deformation mechanisms may involve moving shear bands (i.e., discontinuities where localized deformation occurs) in a spinodal glass matrix microconstituent, which are blunted by localized deformation induced changes (LDIC) described further herein. With increasing levels of stress, once a shear band is blunted, new shear bands may be nucleated and then interact with existing shear bands creating relatively high shear band densities in tension and the development of relatively significant levels of global plasticity. Thus, the alloys with favorable SGMM structures may prevent or mitigate shear band propagation in tension, which may result in relatively significant tensile ductility (>1%) and lead to strain hardening during tensile testing. The alloys contemplated herein may include or consist of chemistries capable of forming a spinodal glass matrix microconstituent, wherein the spinodal glass matrix microconstituents may be present in the range of 5.0% to 95% by volume, including glassy, semi-crystalline, and/or crystalline phases.

Glass forming chemistries that may be used to form compositions including the spinodal glass matrix microconstituent structures may include certain iron based glass forming alloys, which are then processed to provide the SGMM structures noted herein. The iron based alloys may include iron present at levels of greater than or equal to 45 atomic %. In addition, the alloys may include the elements nickel, boron, silicon and optionally chromium. In some embodiments, the alloys may consist essentially of or may be limited only to iron, nickel, boron, silicon and optionally chromium. In further embodiments, the alloys do not include cobalt, which would otherwise increase the relative cost of the alloy compositions.

In some embodiments, the alloys include iron present in the range of 45 atomic percent to 71 atomic percent, nickel present in the range of 4 atomic percent to 17.5 atomic percent, boron present in the range of 11 atomic percent to 16 atomic percent, silicon present in the range of 0.3 atomic percent to 4.0 atomic percent and optionally chromium present in the range of 0.1 atomic percent to 19 atomic percent. The compositions of the alloys may vary at all values and increments in the above described ranges.

Therefore, iron is selected from the following values of 45.0 atomic percent (at. %), 45.1 at.%, 45.2 at. %, 45.3 at. %, 45.4 at. %, 45.6 at. %, 45.7 at. %, 45.8 at. %, 45.9 at. %, 46.0 at. %, 46.1 at. %, 46.2 at. %, 46.3 at. %, 46.4 at.%, 46.5 at. %, 46.7 at. %, 46.8 at. %, 46.9 at. %, 47.0 at. %, 47.1 at. %, 47.2 at. %, 47.3 at. %,47.4 at. %, 47.5 at. %, 47.6 at. %, 47.7 at. %, 47.8 at. %, 47.9 at. %, 48 at. %, 48.1 at. %, 48.2 at. %, 48.3 at. %, 48.4 at. %, 48.5 at. %, 48.6 at. %, 48.7 at. %, 48.8 at. %, 48.9 at. %, 49 at. %, 49.1 at. %, 49.2 at. %, 49.3 at. %, 49.4 at. %, 49.5 at. %, 49.6 at. %, 49.7 at. %, 49.8 at. %, 49.9 at. %, 50 at. %, 50.1 at. %, 50.2 at. %, 50.3 at. %, 50.4 at. %, 50.5 at. %, 50.6 at. %, 50.7 at. %, 50.8 at. %, 50.9 at. %, 51 at. %, 51.1 at. %, 51.2 at. %, 51.3 at. %, 51.4 at. %, 51.5 at. %, 51.6 at. %, 51.7 at. %, 51.8 at. %, 51.9 at. %, 52 at. %, 52.1 at. %, 52.2 at. %, 52.3 at. %, 52.4 at. %, 52.5 at. %, 52.6 at. %, 52.7 at. %, 52.8 at. %, 52.9 at. %, 53 at. %, 53.1 at. %, 53.2 at. %, 53.3 at. %, 53.4 at. %, 53.5 at. %, 53.6 at. %, 53.7 at. %, 53.8 at. %, 53.9 at. %, 54 at. %, 54.1 at. %, 54.2 at. %, 54.3 at. %, 54.4 at. %, 54.5 at. %, 54.6 at. %, 54.7 at. %, 54.8 at. %, 54.9 at. %, 55 at. %, 55.1 at. %, 55.2 at. %, 55.3 at. %, 55.4 at. %, 55.5 at. %, 55.6 at. %, 55.7 at. %, 55.8 at. %, 55.9 at. %, 56 at. %, 56.1 at. %, 56.2 at. %, 56.3 at. %, 56.4 at. %, 56.5 at. %, 56.6 at. %, 56.7 at. %, 56.8 at. %, 56.9 at. %, 57 at. %, 57.1 at. %, 57.2 at. %, 57.3 at. %, 57.4 at. %, 57.5 at. %, 57.6 at. %, 57.7 at. %, 57.8 at. %, 57.9 at. %, 58 at. %, 58.1 at. %, 58.2 at. %, 58.3 at. %, 58.4 at. %, 58.5 at. %, 58.6 at. %, 58.7 at. %, 58.8 at. %, 58.9 at. %, 59 at. %, 59.1 at. %, 59.2 at. %, 59.3 at. %, 59.4 at. %, 59.5 at. %, 59.6 at. %, 59.7 at. %, 59.8 at. %, 59.9 at. %, 60 at. %, 60.1 at. %, 60.2 at. %, 60.3 at. %, 60.4 at. %, 60.5 at. %, 60.6 at. %, 60.7 at. %, 60.8 at. %, 60.9 at. %, 61 at. %, 61.1 at. %, 61.2 at. %, 61.3 at. %, 61.4 at. %, 61.5 at. %, 61.6 at. %, 61.7 at. %, 61.8 at. %, 61.9 at. %, 62 at. %, 62.1 at. %, 62.2 at. %, 62.3 at. %, 62.4 at. %, 62.5 at. %, 62.6 at. %, 62.7 at. %, 62.8 at. %, 62.9 at. %, 63 at. %, 63.1 at. %, 63.2 at. %, 63.3 at. %, 63.4 at. %, 63.5 at. %, 63.6 at. %, 63.7 at. %, 63.8 at. %, 63.9 at. %, 64 at. %, 64.1 at. %, 64.2 at. %, 64.3 at. %, 64.4 at. %, 64.5 at. %, 64.6 at. %, 64.7 at. %, 64.8 at. %, 64.9 at. %, 65 at. %, 65.1 at. %, 65.2 at. %, 65.3 at. %, 65.4 at. %, 65.5 at. %, 65.6 at. %, 65.7 at. %, 65.8 at. %, 65.9 at. %, 66 at. %, 66.1 at. %, 66.2 at. %, 66.3 at. %, 66.4 at. %, 66.5 at. %, 66.6 at. %, 66.7 at. %, 66.8 at. %, 66.9 at. %, 67 at. %, 67.1 at. %, 67.2 at. %, 67.3 at. %, 67.4 at. %, 67.5 at. %, 67.6 at. %, 67.7 at. %, 67.8 at. %, 67.9 at. %, 68 at. %, 68.1 at. %, 68.2 at. %, 68.3 at. %, 68.4 at. %, 68.5 at. %, 68.6 at. %, 68.7 at. %, 68.8 at. %, 68.9 at. %, 69 at. %, 69.1 at. %, 69.2 at. %, 69.3 at. %, 69.4 at. %, 69.5 at. %, 69.6 at. %, 69.7 at. %, 69.8 at. %, 69.9 at. %, 70 at. %, 70.1 at. %, 70.2 at. %, 70.3 at. %, 70.4 at. %, 70.5 at. %, 70.6 at. %, 70.7 at. %, 70.8 at. %, 70.9 at. %, and/or 71 at. %.

Nickel is selected from the following values of 4.0 at. %, 4.1 at. %, 4.2 at. %, 4.3 at. %, 4.4 at. %, 4.5 at. %, 4.6 at. %, 4.7 at. %, 4.8 at. %, 4.9 at. %, 5 at. %, 5.1 at. %, 5.2 at. %, 5.3 at. %, 5.4 at. %, 5.5 at. %, 5.6 at. %, 5.7 at. %, 5.8 at. %, 5.9 at. %, 6 at. %, 6.1 at. %, 6.2 at. %, 6.3 at. %, 6.4 at. %, 6.5 at. %, 6.6 at. %, 6.7 at. %, 6.8 at. %, 6.9 at. %, 7 at. %, 7.1 at. %, 7.2 at. %, 7.3 at. %, 7.4 at. %, 7.5 at. %, 7.6 at. %, 7.7 at. %, 7.8 at. %, 7.9 at. %, 8 at. %, 8.1 at. %, 8.2 at. %, 8.3 at. %, 8.4 at. %, 8.5 at. %, 8.6 at. %, 8.7 at. %, 8.8 at. %, 8.9 at. %, 9 at. %, 9.1 at. %, 9.2 at. %, 9.3 at. %, 9.4 at. %, 9.5 at. %, 9.6 at. %, 9.7 at. %, 9.8 at. %, 9.9 at. %, 10 at. %, 10.1 at. %, 10.2 at. %, 10.3 at. %, 10.4 at. %, 10.5 at. %, 10.6 at. %, 10.7 at. %, 10.8 at. %, 10.9 at. %, 11 at. %, 11.1 at. %, 11.2 at. %, 11.3 at. %, 11.4 at. %, 11.5 at. %, 11.6 at. %, 11.7 at. %, 11.8 at. %, 11.9 at. %, 12 at. %, 12.1 at. %, 12.2 at. %, 12.3 at. %, 12.4 at. %, 12.5 at. %, 12.6 at. %, 12.7 at. %, 12.8 at. %, 12.9 at. %, 13 at. %, 13.1 at. %, 13.2 at. %, 13.3 at. %, 13.4 at. %, 13.5 at. %, 13.6 at. %, 13.7 at. %, 13.8 at. %, 13.9 at. %, 14 at. %, 14.1 at. %, 14.2 at. %, 14.3 at. %, 14.4 at. %, 14.5 at. %, 14.6 at. %, 14.7 at. %, 14.8 at. %, 14.9 at. %, 15 at. %, 15.1 at. %, 15.2 at. %, 15.3 at. %, 15.4 at. %, 15.5 at. %, 15.6 at. %, 15.7 at. %, 15.8 at. %, 15.9 at. %, 16.0 at. %, 16.1 at. %, 16.2 at. %, 16.3 at. %, 16.4 at.%, 16.5. at. %, 16.6 at. %, 16.7. at. %, 16.8 at. %, 16.9 at. %, 17.0 at. %, 17.1 at. %, 17.2 at. %, 17.3 at. %, 17.4 at. %, 17.5 at. %.

Boron is selected from the following values of 11.0 at. %, 11.1 at. %, 11.2 at. %, 11.3 at. %, 11.4 at. %, 11.5 at. %, 11.6 at. %, 11.7 at. %, 11.8 at. %, 11.9 at. %, 12 at. %, 12.1 at. %, 12.2 at. %, 12. 3 at. %, 12.4 at. %, 12.5 at. %, 12.6 at. %, 12.7 at. %, 12.8 at. %, 12.9 at. %, 13 at. %, 13.1 at. %, 13.2 at. %, 13.3 at. %, 13.4 at. %, 13.5 at. %, 13.6 at. %, 13.7 at. %, 13.8 at. %, 13.9 at. %, 14 at. %, 14.1 at. %, 14.2 at. %, 14.3 at. %, 14.4 at. %, 14.5 at. %, 14.6 at. %, 14.7 at. %, 14.8 at. %, 14.9 at. %, 15 at. %, 15.1 at. %, 15.2 at. %, 15.3 at. %, 15.4 at. %, 15.5 at. %, 15.6 at. %, 15.7 at. %, 15.8 at. %, 15.9 at. %, 16 at. %.

Silicon is selected from the following values of 0.3 at. %, 0.4 at. %, 0.5 at. %, 0.6 at. %, 0.7 at.%, 0.8 at. %, 0.9 at. %, 1.0 at. %, 1.1 at. %, 1.2 at. %, 1.3 at. %, 1.4 at. %, 1.5 at. %, 1.6 at. 5, 1.7 at. %, 1.8 at.%, 1.9 at. %, 2.0 at. %, 2.1 at. %, 2.2 at. %, 2.3 at. %, 2.4 at. %, 2.5 at. %, 2.6 at. %, 2.7 at. %, 2.8 at. %, 2.9 at. % 3.0 at. %, 3.1 at. %, 3.2 at. %, 3.3 at. %, 3.4 at. %, 3.5 at. %, 3.6 at. %, 3.7 at. %, 3.8 at. %, 3.9 at. % 4.0 at. %.

Chromium is selected from the following values of 0 at. %, 0.1 at. %, 0.2 at. %, 0.3 at. %, 0.4 at. %, 0.5 at. %, 0.6 at. %, 0.7 at. %, 0.8 at. %, 0.9 at. %, 1 at. %, 1.1 at. %, 1.2 at. %, 1.3 at. %, 1.4 at. %, 1.5 at. %, 1.6 at. %, 1.7 at. %, 1.8 at. %, 1.9 at. %, 2 at. %, 2.1 at. %, 2.2 at. %, 2.3 at. %, 2.4 at. %, 2.5 at. %, 2.6 at. %, 2.7 at. %, 2.8 at. %, 2.9 at. %, 3 at. %, 3.1 at. %, 3.2 at. %, 3.3 at. %, 3.4 at. %, 3.5 at. %, 3.6 at. %, 3.7 at. %, 3.8 at. %, 3.9 at. %, 4 at. %, 4.1 at. %, 4.2 at. %, 4.3 at. %, 4.4 at. %, 4.5 at. %, 4.6 at. %, 4.7 at. %, 4.8 at. %, 4.9 at. %, 5 at. %, 5.1 at. %, 5.2 at. %, 5.3 at. %, 5.4 at. %, 5.5 at. %, 5.6 at. %, 5.7 at. %, 5.8 at. %, 5.9 at. %, 6 at. %, 6.1 at. %, 6.2 at. %, 6.3 at. %, 6.4 at. %, 6.5 at. %, 6.6 at. %, 6.7 at. %, 6.8 at. %, 6.9 at. %, 7 at. %, 7.1 at. %, 7.2 at. %, 7.3 at. %, 7.4 at. %, 7.5 at. %, 7.6 at. %, 7.7 at. %, 7.8 at. %, 7.9 at. %, 8 at. %, 8.1 at. %, 8.2 at. %, 8.3 at. %, 8.4 at. %, 8.5 at. %, 8.6 at. %, 8.7 at. %, 8.8 at. %, 8.9 at. %, 9 at. %, 9.1 at. %, 9.2 at. %, 9.3 at. %, 9.4 at. %, 9.5 at. %, 9.6 at. %, 9.7 at. %, 9.8 at. %, 9.9 at. %, 10 at. %, 10.1 at. %, 10.2 at. %, 10.3 at. %, 10.4 at. %, 10.5 at. %, 10.6 at. %, 10.7 at. %, 10.8 at. %, 10.9 at. %, 11 at. %, 11.1 at. %, 11.2 at. %, 11.3 at. %, 11.4 at. %, 11.5 at. %, 11.6 at. %, 11.7 at. %, 11.8 at. %, 11.9 at. %, 12 at. %, 12.1 at. %, 12.2 at. %, 12.3 at. %, 12.4 at. %, 12.5 at. %, 12.6 at. %, 12.7 at. %, 12.8 at. %, 12.9 at. %, 13 at. %, 13.1 at. %, 13.2 at. %, 13.3 at. %, 13.4 at. %, 13.5 at. %, 13.6 at. %, 13.7 at. %, 13.8 at. %, 13.9 at. %, 14 at. %, 14.1 at. %, 14.2 at. %, 14.3 at. %, 14.4 at. %, 14.5 at. %, 14.6 at. %, 14.7 at. %, 14.8 at. %, 14.9 at. %, 15 at. %, 15.1 at. %, 15.2 at. %, 15.3 at. %, 15.4 at. %, 15.5 at. %, 15.6 at. %, 15.7 at. %, 15.8 at. %, 15.9 at. %, 16 at. %, 16.1 at. %, 16.2 at. %, 16.3 at. %, 16.4 at. %, 16.5 at. %, 16.6 at. %, 16.7 at. %, 16.8 at. %, 16.9 at. %, 17 at. %, 17.1 at. %, 17.2 at. %, 17.3 at. %, 17.4 at. %, 17.5 at. %, 17.6 at. %, 17.7 at. %, 17.8 at. %, 17.9 at. %, 18 at. %, 18.1 at. %, 18.2 at. %, 18.3 at. %, 18.4 at. %, 18.5 at. %, 18.6 at. %, 18.7 at. %, 18.8 at. %, 18.9 at. %, and/or 19 at. %.

In addition, due to, for example, the purity of the feedstocks and introduction of impurities during processing, the alloys may include up to 10 atomic percent of impurities. Therefore, the above described iron based alloy composition may be present in the range of 90 to 100 atomic percent of a given composition, including all values and increments therein, such as in the range of 90 to 99 atomic percent, etc.

While not intended to be limiting, an analysis of the mechanisms of deformation appear to show that that the operating mechanisms for ISBB and SBAI are orders of magnitude smaller than the system size. The operable system size may be understood as the volume of material containing the SGMM structure, which again may be in the range of 5% to 95% by volume. Additionally, for a liquid melt cooling on a chill surface such as a wheel or roller (which can be as wide as engineering will allow) 2-dimensional cooling may be a predominant factor in spinodal glass matrix microconstituent formation, thus the thickness may be a limiting factor on structure formation and resulting operable system size. At thicknesses above a reasonable system size compared to the mechanism size, the ductility mechanism may be unaffected. For example, the shear band widths may be relatively small (10 to 100 nm) and even with the LDIC interactions with the structure the interaction size may be from 20 to 200 nm. Thus, for example, achievement of relatively significant ductility (>1%) at a 100 micron thickness means that the system thickness is already 500 to 10,000 times greater than ductility mechanism sizes.

It is contemplated that the operable system size, which when exceeded would allow for ISBB and SBAI interactions, may be in the range of ˜10 nm to 1 micron in thickness or 1000 nm³ to 1 μm³ in volume. Achieving thicknesses greater than ˜1 micron or operable volumes greater than 1 μm³ may not be expected to significantly affect the operable mechanisms or achievement of significant levels of plasticity since the operable ductility mechanistic size is below this limit. Thus, greater thickness or greater volume samples or products would be contemplated to achieve an operable ductility with ISBB and SBAI mechanisms in a similar fashion as identified as long as the SGMM structure is formed.

The foil is formed using techniques that may result in cooling rates sufficient to provide SGMM structure, which may be in the range of 10³ to 10⁶ K/s. Examples of such processing techniques may include melt-spinning/jet casting, planar flow casting, and twin roll casting.

Melt spinning is understood to include a liquid melt ejected using gas pressure onto a rapidly moving metallic wheel which may be made of copper. Continuous or broken up lengths of ribbon may be produced. In some embodiments, the ribbon may be in the range of 1 mm to 2 mm wide and 0.015 to 0.15 mm thick, including all values and increments therein. The width and thickness may depend on the melt spun materials viscosity and surface tension and the wheel tangential velocity. Typical cooling rates in the melt-spinning process may be from ˜10⁴ to ˜10⁶ K/s, including all values and increments therein. Ribbons may generally be produced in a continuous fashion up to 25 m long using a laboratory scale system.

Jet casters may be used to melt-spin alloys on a commercial scale. Process parameters in one embodiment of melt spinning may include providing the liquid melt in a chamber, which is in an environment including air or an inert gas, such as helium, carbon dioxide, carbon dioxide and carbon monoxide mixtures, or carbon dioxide and argon mixtures. The chamber pressure may be in the range of 0.25 atm to 1 atm, including all values and increments therein. Further, the casting wheel tangential velocity may be in the range of 15 meters per second (m/s) to 30 m/s, including all values and increments therein. Resulting ejection pressures may be in the range of 100 to 300 mbar and resulting ejection temperatures may be in the range of 1000° C. to 1300° C., including all values and increments therein.

Planar flow casting is understood as a relatively low cost and relatively high volume technique to produce wide ribbon in the form of continuous sheet. The process may include flowing a liquid melt at a close distance over a chill surface. Widths of thin foil/sheet up to 10″ (254 mm), including all values and increments in the range of 10 mm to 254mm, may be produced on a commercial scale with thickness in the range of 0.016 to 0.075 mm, including all values and increments therein. Cooling rates in the range of ˜10⁴ to ˜10⁶ K/s, including all values and increments therein may be provided.

Twin roll casting is understood to include quenching a liquid melt between two rollers rotating in opposite directions. Solidification may begin at first contact between the upper part of each of the rolls and the liquid melt. Two individual shells may begin to form on each chill surface and, as the process continues, may be subsequently brought together at the roll nip by the chill rolls to form one continuous sheet. In this approach, solidification may occur rapidly and direct melt thicknesses may be achieved much thinner than conventional melt processes and typically into the 1.5 mm to 3.0 mm range prior to any post processing steps such as hot rolling. The process is similar in many ways to planar flow casting, yet a main differences is that two chill rollers may used to produce sheet in twin roll casting rather than a single chill roller in planar flow casting. However, in the context of the sheet that may be produced herein, having the indicated SGMM structure, the thickness may be in the range of 0.5 mm to 5.0 mm.

The solidified iron based alloys may have a density in the range of 7.40 g/cm³ to 7.80 g/cm³, including all values and increments therein. In addition, the iron based alloys may exhibit a glass to crystalline transformation temperature in the range of approximately 396° C. to 713° C., including all values and ranges therein, when measured by differential thermal analysis (DTA) or differential scanning calorimetry (DSC) at a heating rate of 10° C./minute. The enthalpy of transformation may be in the range of −16 J/gram to −167 J/gram, including all values and increments therein, when measured by differential thermal analysis (DTA) or differential scanning calorimetry (DSC) at a heating rate of 10° C./minute.

The iron based alloys may exhibit 180 degree bending, where ribbons having a thickness in the range of 0.020 mm to 0.060 mm may be bent over completely flat. The iron based alloys may also exhibit an ultimate tensile strength in the range of 0.4 GPa to 3.90 GPa, including all values and ranges therein, such as 1.00 GPa to 3.26 GPa, when tested at a strain rate of 0.001 s⁻¹. In addition, the iron based alloys may exhibit a total elongation in the range of 0.4% to 5.5%, including all values and ranges therein, such as 1.0% to 5.5%, when tested at a strain rate of 0.001 s⁻¹. The alloys may exhibit a Vickers hardness in the range of 850 to 950, including all values and ranges therein, when tested with a diamond pyramid indenter using a 50 g load. The alloys may also exhibit a shear band density of at least 90×10³/meter to 300×10³/meter, including all values and ranges therein. The presence of the ductility and the relatively high shear band density indicate that SGMM structures have formed in the alloys.

Due to the exceptionally high strength and hardness of the glassy steel foil, the resistance to damage from a high speed impact (Impact Resistance) is expected to be greatly improved. A 2× improvement over TiGR may be achieved due to the fact that the ultimate tensile strength of the foil is twice that of Ti-6Al-4V Titanium alloy. Table 1, below, shows a comparison of material properties between 2024-T3 aluminum (used in GLARE), Ti-6Al-4V titanium (used in TiGR), and the glassy steel alloy foil contemplated herein.

TABLE 1
Comparison of Properties

| | | Titanium | |
|---|---|---|---|
| | 2024-T3 | Ti—6%Al—4%V | Glassy |
| | Alumi- | (ASTM | Steel |
| PROPERTY | num* | Grade 5)* | Foil |
| Tensile Yield Strength [MPa] | 345 | 880 | 1800 |
| Ultimate Tensile Strength | 483 | 950 | 2500 |
| [MPa] | | | |
| DAMAGE TOLERANCE | TBD | TBD | TBD |
| (residual tensile strength after | | | |
| impact [MPa]) | | | |
| IMPACT RESISTANCE | TBD | TBD | TBD |
| (impact energy that causes | | | |
| cracking or delaminating [J]) | | | |
| FATIGUE STRENGTH | 138 | 510 | 338 |
| [MPa for 1E+7 Cycles] | | | |
| WEAR RESISTANCE | 137 | 349 | 900 |
| (Hardness [100 Hv]) | | | |
| FLAME RESISTANCE | 121 | 6.7 | 7.6 |
| (Thermal Conductivity | | | |
| [W/m-K]) | | | |
| Thickness (as used in | 0.300 | 0.200 | .038 |
| GLARE, TiGR, or Glassy | | | |
| Metal foil [mm]) | | | |

*www.matweb.com, MatWeb, LLC.

Damage tolerance is also expected to improve when using a glassy steel foil in an FML structure. The glassy steel foil is produced with a typical thickness in the range of 0.020 mm to 0.05 1mm, including all values and ranges therein, and therefore requires more layers than GLARE™ or TiGR™ to achieve an equivalent strength. Damage tolerance is the residual strength of the FML after impact and is generally tested after an impact with just enough energy to cause a crack to form. Cracking will typically only occur on the front (impacted) layer of foil so the residual strength will be affected less than that of GLARE or TiGR.

For example, a GLARE™ 3 3/2 FML layup contains 3 layers of 2024-T3 aluminum and if one of the layers is damaged then the full structure will lose approximately ⅓rd of the strength of the metallic component of the FML. The same FML structure made from glassy steel foil requires 7 layers of foil and if one is damaged, only 1/7th of the strength of the metallic component is lost.

Apart from the above example, FML structures herein may include one or more layers of metal foil, such as up to 20 or 30 layers of foil, including all values and ranges therein, such as 1 to 5, 2 to 10, 10 to 20, etc, and one or more layers of fiber reinforced polymer. The foil may be interleaved with the reinforced composite materials (i.e., fiber reinforced polymer layers) in an alternating manner, multiple layers of foil may be positioned between two layers of reinforced composite, or multiple layers of reinforced composite may be positioned between two layers of foil. Where multiple layers of foil are stacked together, the foil layers may be tacked together or an adhesive may be utilized to tack the foils together. Stacked, or stacking, is understood to imply the arrangement of the layers in a pile.

Improved adhesion between the glassy steel foil and matrix can be achieved through the use of silane surface treatments applied to the metal and/or silane additives applied to the matrix. Silane treatments create a covalent bond between organic and inorganic materials which act to augment adhesion and cohesion between the glassy steel and matrix. One example of a silane is a 3-glycidoxypropyltrimethoxysilane which can be applied to the glassy steel foil surface. Treated foils and/or matrix materials can be added to the fiber reinforced epoxy composite layup in a stacked configuration, which can then be put in an oven to cure.

An additional method to produce the fiber metal laminate structure is the Fiber Metal Laminate Vacuum Assisted Resin Transfer Molding (FML-VARTM) process developed by NASA to eliminate air entrapment and improve manufacturability. In the FML-VARTM process alternating layers of reinforcing fibers and glassy steel foil can be stacked in a layup and placed in a vacuum bag, which is outfitted with resin flow tubes so that the liquid epoxy resin can be injected into the fiber metal laminate structure by flowing from one side of the laminate to the other.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A glassy metal fiber laminate, comprising:
a fiber reinforced polymer layer, wherein said fiber reinforced polymer layer comprises fibers present in a polymer matrix; and
a glassy metal foil layer stacked with said fiber reinforced polymer layer, wherein said glassy metal foil layer comprises an iron based glass forming alloy including nickel, boron, silicon and optionally chromium and exhibits spinodal glass matrix microconstituents including a glass matrix and a semicrystalline/crystalline phase.

2. The glassy metal fiber laminate of claim 1, wherein said iron based glass forming alloy comprises 45.0 at % to 71 at % iron, 4.0 at % to 17.5 at % nickel, 11.0 at % to 16 at % boron, 0.3 at % to 4.0 at % silicon, 0 at % to 19 at % chromium.

3. The glassy metal fiber laminate of claim 1, including 1 to 30 layers of glassy metal foil.

4. The glassy metal fiber laminate of claim 1, including a plurality of said glassy metal foil layers interleaved with a plurality of said fiber reinforced polymer layers in an alternating manner.

5. The glassy metal fiber laminate of claim 1, including a plurality of said fiber reinforced polymer layers between a first layer of said glassy metal foil and a second layer of said glassy metal foil.

6. The glassy metal fiber laminate of claim 1, including a plurality of said glassy metal foil layers positioned between a first fiber reinforced polymer layer and a second fiber reinforced polymer layer.

7. The glassy metal fiber laminate of claim 1, wherein said glassy metal foil layer includes a silane surface treatment.

8. The glassy metal fiber laminate of claim 1, wherein said polymer matrix includes a silane additive.

9. The glassy metal fiber laminate of claim 1, wherein said fibers include one or more fibers selected from the group consisting of: carbon, glass and aramid.

10. The glassy metal fiber laminate of claim 1, wherein said matrix includes one or more polymers selected from the group consisting of: epoxy thermoset resin, vinylester thermoset resin, polyester thermoset resin, phenol formaldehyde thermoset resin, polyethylene terephthalate, polyether ether ketone, polysulfone, and polyetherimide.

11. A method of forming a glassy metal fiber laminate comprising:
providing a fiber reinforced polymer layer, wherein said fiber reinforced polymer layer comprises fibers present in a polymer matrix;
providing a glassy metal foil layer, wherein said glassy metal foil layer comprises an iron based glass forming alloy including nickel, boron, silicon and optionally chromium and exhibits spinodal glass matrix microconstituents including a glass matrix and a semicrystalline/crystalline phase; and
forming a laminate of said fiber reinforced polymer layer and said glassy metal foil layer.

12. The method of claim 11, wherein said iron based glass forming alloy comprises 45.0 at % to 71 at % iron, 4.0 at % to 17.5 at % nickel, 11.0 at % to 16 at % boron, 0.3 at % to 4.0 at % silicon, 0 at % to 19 at % chromium.

13. The method of claim 11, wherein said fibers include one or more fibers selected from the group consisting of: carbon, glass and aramid; and said matrix includes one or more polymers selected from the group consisting of: epoxy thermoset resin, vinylester thermoset resin, polyester thermoset resin, phenol formaldehyde thermoset resin, polyethylene terephthalate, polyether ether ketone, polysulfone, and polyetherimide.

14. The method of claim 11, further comprising treating said glassy metal foil layer with a silane and bonding said glassy metal foil layer with said polymer matrix.

15. The method of claim 11, wherein said polymer matrix includes a silane additives and said method further comprises bonding said glassy metal foil layer with said polymer matrix.

16. The method of claim 11, further comprising interleaving a plurality of glassy metal foil layers interleaved with a plurality of said fiber reinforced polymer layers in an alternating manner.

17. The method of claim 16, wherein said interleaved glassy metal foil layers and said fiber reinforced polymer layers are placed in a vacuum bag and resin is injected into the interleaved glassy metal foil layers and said fiber reinforced polymer layers.

18. The method of claim 11, further comprising stacking a plurality of said glassy metal foil layers together and applying an adhesive to tack said glassy metal foil layers together.

19. The method of claim 11, wherein said glassy metal foil layer is formed using a cooling rate in the range of 10³ K/s to 10⁶ K/s.

20. The method of claim 11, wherein said glassy metal foil layer is formed by twin roll casting and exhibits a thickness in the range of 0.5 mm to 5.0 mm.
